(19) United States
(12) Patent Application Publication
(10) Pub. No.: US 2003/0135643 A1
(43) Pub. Date: Jul. 17, 2003

(54) Data transmission scheduling system and method

(76) Inventors: Chaucer Chiu, Taipei (TW); Xiao-Hui Shao, Shanghai (CN)

Correspondence Address: BIRCH STEWART KOLASCH & BIRCH, PO BOX 747, FALLS CHURCH, VA, 22040-0747, US

(21) Appl. No.: 10/042,230

(22) Filed: Jan. 11, 2002

(51) Int. Cl. G06F 15/173; G06F 9/00

(52) U.S. Cl. 709/238

(57) ABSTRACT

A data transmission scheduling system and method, which utilizes the transmission character of a wireless network to schedule data updating and downloading, and to design a customized transmission mechanism. According to the scheduling plan defined by the user in advance, the system triggers a transmission mechanism to complete a data transmission task when a certain schedule condition is detected to be valid. The system is comprised of a starting module, a schedule defining module, a schedule adding module, a schedule removal module, a schedule executing module, a self-adjusting transmission module, and a schedule diary module. The system establishes and executes tasks according to the schedule. Using the disclosed method can avoid network transmission jams to effectively increase data transmission efficiency of the wireless network.

### BACKGROUND OF THE INVENTION

1. Field of Invention

The invention relates to a scheduling system and the method which utilize the transmission character of a wireless network to schedule data updating and downloading. More particular, it relates to a data transmission scheduling and the method for the same.

2. Related Art

With recent advances and maturity of the wireless communications technology, various broad band or narrow band wireless communication network have been set up. Different kinds of handheld and vehicle mobile communication devices have been designed. Data transmissions through wireless networks have a fast growing trend. How to utilize the characters of wireless networks to increase data transmission efficiency has become one of the most important subjects concerned by the public.

When transmitting data, current mobile transmission devices usually adopt real-time transmissions. That is, when a user makes a data transmission request, the device immediately transmits data through a network. For instance, when a user uses a WAP (Wireless Application Protocol) to browse the Internet and download data, some non-real-time and non-interactive data transmission jobs, such as downloading large-volume electronic media and particularly repeated automatic data updates, obviously do not fully appreciate such characters as no dialup needed and online immediately once the system is powered on. Most data are transmitted at a certain time (usually work time), causing channel jams in the wireless network and thus greatly reducing the communications efficiency.

Wireless networks usually have the characters of no dialup required and being online after power on. Wireless networks based upon the group exchange technology further have such characters as shared channels and the efficiency being lowered as the number of users increases. Taking the current operating system (OS) as an example, it often needs to process multiple utilities. Memory may have more than one utility to process at one time. The CPU (Central Processing Unit), however, can only process one utility at a time. Therefore, it has to select one utility to run. After a certain time, it switches to another utility. Such scheduling in advance to manage system resources does not only save time but also save resources waste. Nevertheless, current mobile communication devices lack of this kind of design concept. It is thus highly desirable to have a simple and convenient data transmission scheduling system to solve these problems.

### SUMMARY OF THE INVENTION

In view of the foregoing, the invention provides a data transmission scheduling system and the method for the same. An objective of the invention is to design a customized transmission mechanism for wireless network transmissions. In accordance with a scheduling plan defined in advance by the user, the system can automatically detect whether the condition of a schedule task is satisfied. If the condition is satisfied, data transmissions are started to effectively increase the data transmission efficiency of the wireless network.

The invention includes at least the following modules: a system starting module to start the data transmission scheduling system; a schedule defining module to define a data transmission task as a schedule task, a schedule adding module to add the already defined schedule task into a database of the data transmission scheduling system, a schedule removal module to remove executed and finished schedule task from the database, a schedule executing module to execute a schedule task when a schedule condition is satisfied, and a self-adjusting module to automatically adjust the execution time of the schedule task.

The invention includes at least the following steps: define a schedule task of data transmissions; add the defined schedule task to a schedule queue; confirm a schedule condition of the schedule task; and perform the data transmission according to the schedule task corresponding to the schedule condition.

### BRIEF DESCRIPTION OF THE DRAWINGS

The invention will become more fully understood from the detailed description given hereinbelow illustration only, and thus are not limitative of the present invention, and wherein:

FIG. 1 is a system structure diagram of the disclosed data transmission scheduling system;

FIG. 2A shows the processing procedure of the schedule defining module in FIG. 1;

FIG. 2B shows the processing procedure of the schedule adding module in FIG. 1;

FIG. 2C shows the processing procedure of the schedule removal module in FIG. 1;

FIG. 2D shows the processing procedure of the schedule executing module in FIG. 1;

FIG. 2E shows the processing procedure of the self-adjusting transmission module in FIG. 1; and

FIG. 3 is a control unit flowchart of the data transmission scheduling system.

### DETAILED DESCRIPTION OF THE INVENTION

This specification discloses a data transmission scheduling system and the method for the same. In particular, a transmission mechanism is designed pursuant to the transmission characters of the wireless network. A schedule defined in advance is used to avoid network transmission rush time. This mechanism defines a schedule plan according to the user's needs of transmitting data through the wireless network. The defined task is added to the data transmission scheduling system in the schedule. The system regularly detects whether any schedule condition is satisfied. When a schedule condition is detected to be satisfied, the system triggers a transmission mechanism to complete the data transmission task.

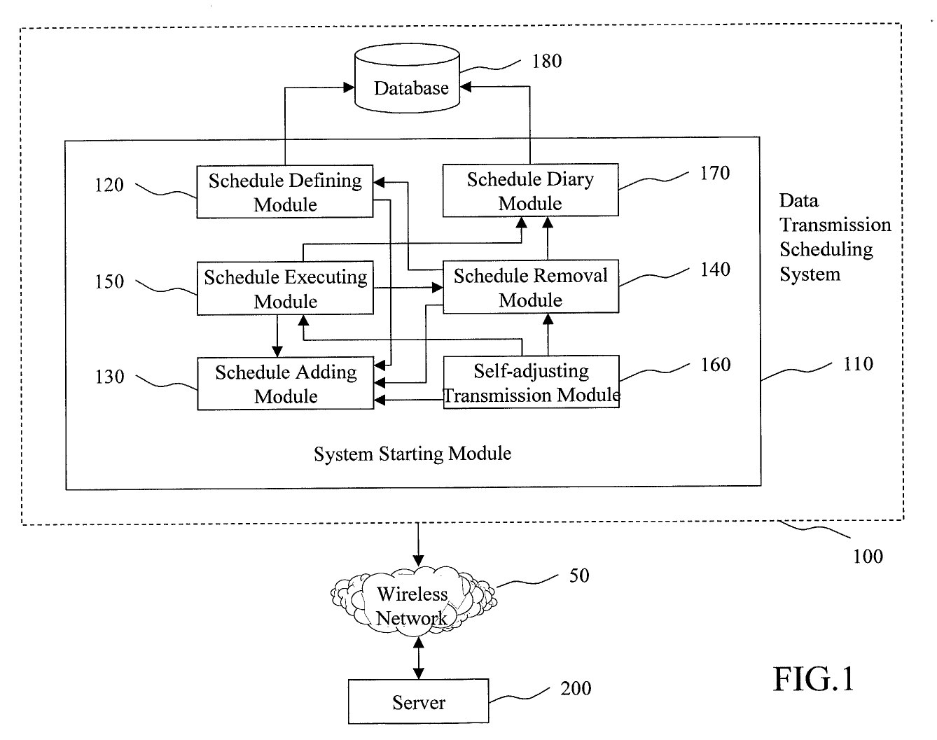

The invention uses a preferred embodiment to explain the feasibility of the disclosed system and method. With reference to FIG. 1, the basic structure of the invention is as follows:

The invention provides a data transmission scheduling system 100, which can be used for data management in an E-book (Electronic book) reader. When a user enters this data transmission scheduling system, the user can utilize various functions in the system to perform data management. The data transmission scheduling system 100 contains: (1) a system starting module 110; (2) a schedule defining module 120; (3) a schedule adding module 130; (4) a schedule removal module 140; (5) a schedule executing module 150; (6) a self-adjusting transmission module 160; and (7) a schedule diary module 170.

(1) The system starting module 110 starts the data transmission scheduling system and becomes a routine in the system. When the power of the E-book reader is turned on, the data transmission scheduling system is automatically started and loaded to monitor all schedule requests and task execution.

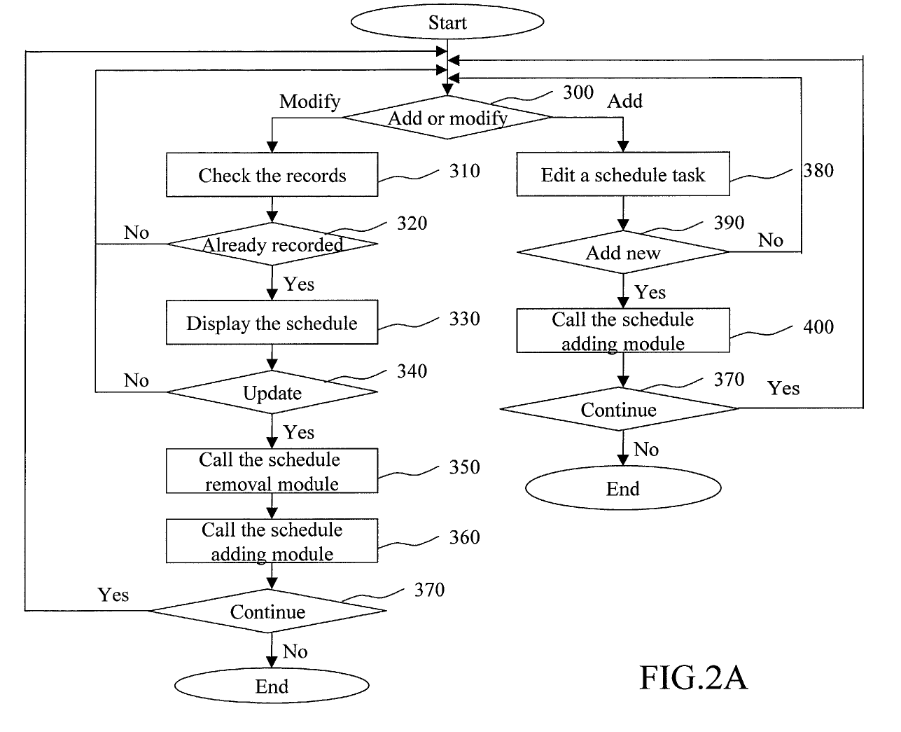

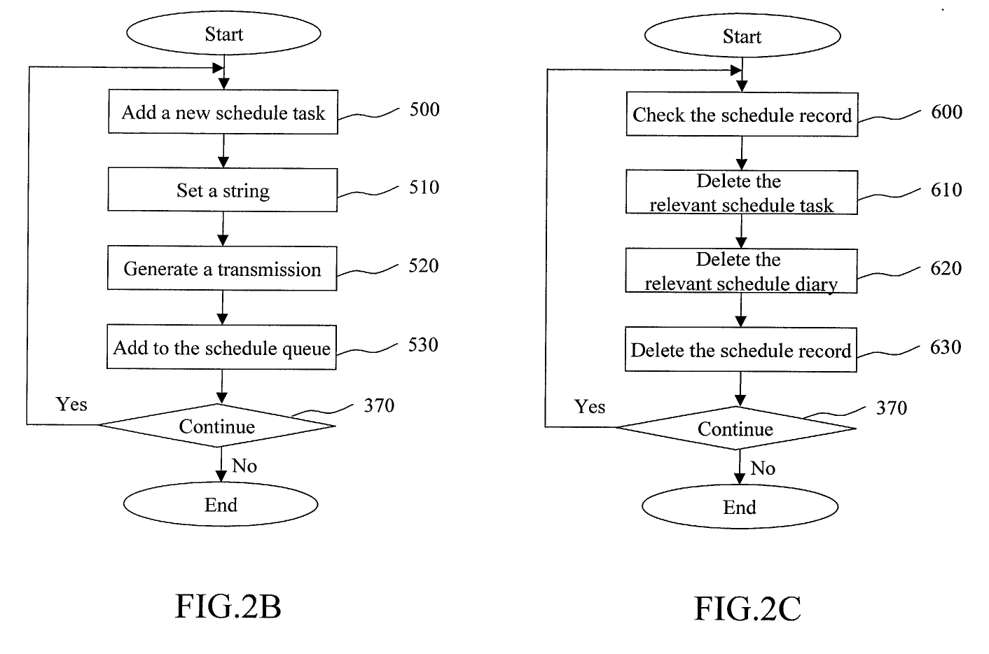

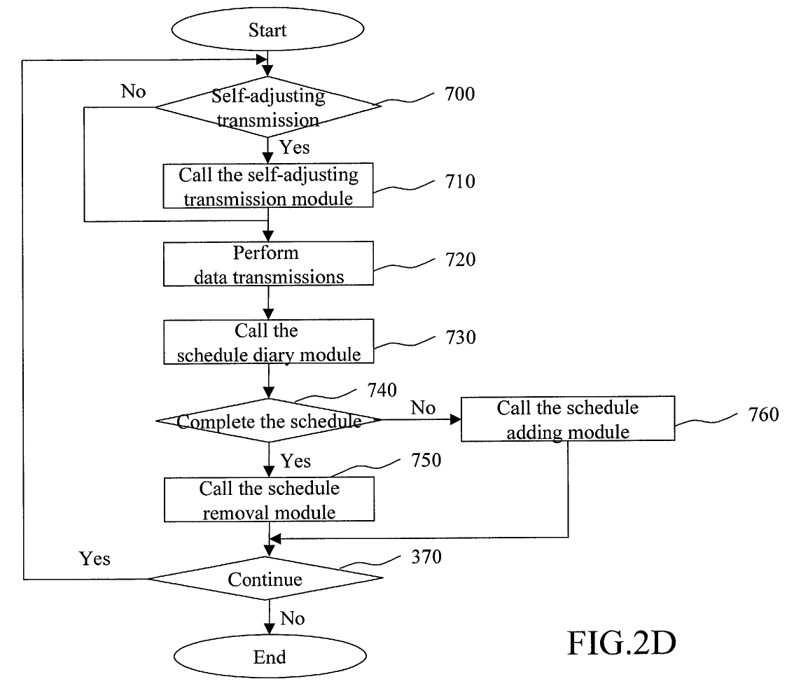

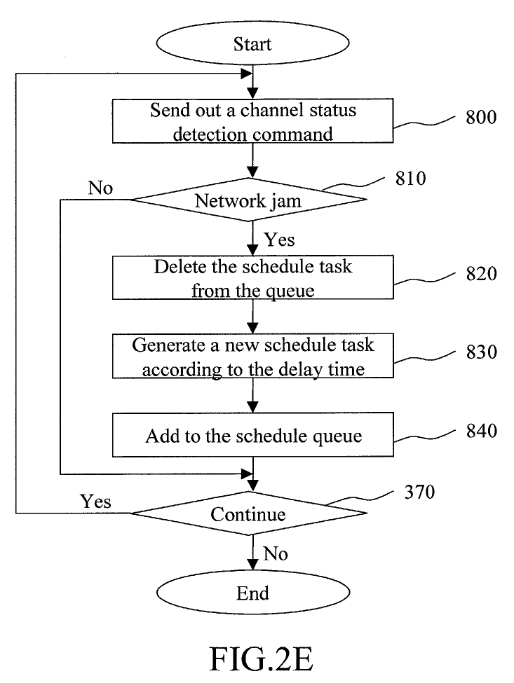

(2) The schedule defining module 120 defines the data transmission task requested by the user as a schedule task. As shown in FIG. 2A, the function and processing procedure of the schedule defining module are as follows:

Through a user interface (UI), one can add or modify (step 300) a schedule task. The schedule stores the task execution rules and transmitted data locations for each schedule task. The task execution rules define the time, number of times, and methods of executing a schedule task. If the rule is to execute a task for one time, then it means that the task is to be executed immediately at a particularly time. If the rule is to execute a task repeatedly, it means that the task is to be executed regularly (e.g. every day, every week or every month). The transmitted data locations indicate where the data sources are. They include the server addresses of the data, the paths of the data files, and the commands of generating files. The data types transmitted through the wireless network can be static files on the server or dynamically generated data by running commands on the server 200. When check the records (step 310). If the record is already recorded (step 320) and exists inside the database 180, display the schedule(step 330). If the user wants to update (step 340) the record, then call the schedule removal module (step 350) and call the schedule adding module (step 360). Afterwards, determines whether the user wants to continue (step 370) using the module. If the user continues using, then step 300 follows; otherwise, the system quits the module. If the user wants to add a new record, then the user defines and edits a schedule task (step 380). Once the schedule task is added new (step 390), call the schedule adding module (step 400) to add the defined task to the queue. If the user wants to continue (step 370), then step 300 follows; otherwise, the system quits the module.

(3) The schedule adding module 130 adds a defined schedule task to the data transmission scheduling system. As shown in FIG. 2B, the functions and processing procedure of the schedule adding module are as follows:

When the user finishes the schedule definition or the user selects to modify a particular schedule record, the schedule database 180 is added a new schedule task (step 500) and sets a string (step 510) according to the schedule definition. According to the execution time in the definition, generate a transmission (step 520) and add to the schedule queue (step 530). If the user wants to continue (step 370) using the module, then step 500 follows; otherwise, the system quits the module.

(4) The schedule removal module 140 removes already executed schedule tasks from the data transmission scheduling system. As shown in FIG. 2C, the functions and processing procedure are as follows:

If the user selects to delete or to modify a particular schedule record, or a particular schedule task is done, the system check the schedule record (step 600) in the schedule database 180 and delete the relevant schedule task (step 610) from the queue. If the user decides to remove a particular schedule record, then delete the relevant schedule diary (step 620) before delete the schedule record (step 630). If the user wants to continue (step 370) using the module, then step 600 follows; otherwise, the system quits the module.

(5) The schedule executing module 150 executes the data transmission task whose scheduling condition is satisfied. As shown in FIG. 2D, the functions and processing procedure are as follows:

When a schedule task is triggered, the data transmission scheduling system detects whether the schedule task choose to use a self-adjusting transmission (step 700). If so, then call the self-adjusting transmission module (step 710) to adjust the time of executing the schedule task. Otherwise, data transmission software is started to perform data transmissions (step 720). The request including data locations is sent to the wireless network 50. After the server 200 receives the request, the requested data are prepared. Once the communications with the mobile communication device is established, a certain transmission protocol is employed to transmit data to the mobile communication device. After this task is finished, call the schedule diary module (step 730) to write the transmission record into the database 180. If Complete the schedule (Step 740), then call the schedule removal module (step 750). Otherwise, call the schedule adding module (step 760). Afterwards, the transmission task is generated according to the previous schedule definition and the current execution time. This newly generated transmission task is then added to the schedule queue. If the user wants to continue (step 370) using the module, then step 600 follows; otherwise, the system quits the module.

(6) The self-adjusting transmission module 160 detects he network transmission condition and automatically adjusts the schedule task execution time. As shown in FIG. 2E, the functions and processing procedure are as follows:

The self-adjusting transmission module can adjust data transmission time by detecting the usage condition of the wireless network 50 (whether there is any traffic jam). When the data transmission starts, the data transmission scheduling system sends out a channel status detection command (step 800) to the wireless network 50. It determines whether the network jam (step 810) according to the returned value. If the network is busy, then a predetermined self-adjusting delay time is used to change the execution time of this transmission task. Delete the schedule task from the queue (step 820), and generate a new schedule task according to the delay time (step 830). The execution time of the new transmission task is then added to the schedule queue (step 840). If the network is not busy, then the schedule executing module performs data transmissions as scheduled. If the user wants to continue (step 370) using the module, then step 600 follows; otherwise, the system quits the module.

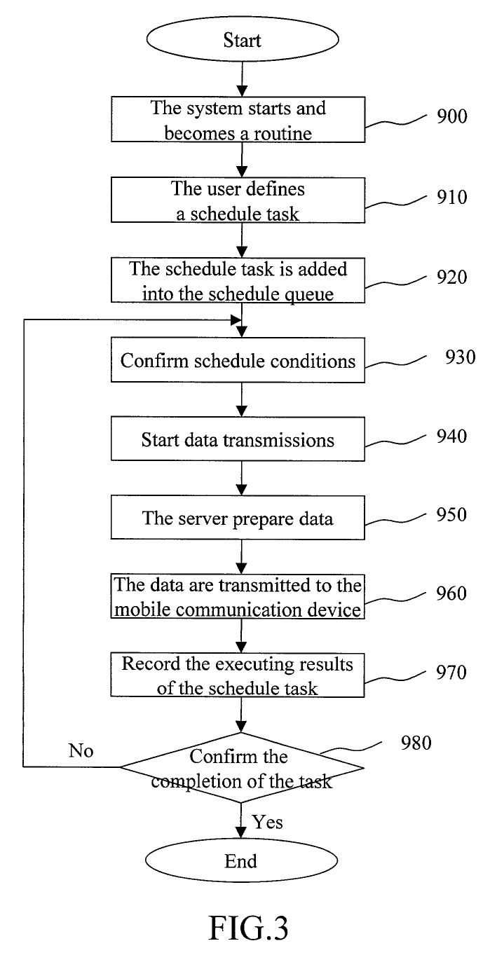

(7) The schedule diary module 170 stores the schedule task executing result in the database 180. With reference to FIG. 3, the main procedure of each module is described as follows:

When the user wants to perform data transmissions through the wireless network 50 or download data from the server 200, then the data transmission scheduling system starts and becomes a routine (step 900). The user defines a schedule task (step 910). The schedule task is added to the schedule queue (step 920). The schedule conditions along with transmitted data locations are used to define schedule tasks. Afterwards, the data transmission scheduling system confirms schedule conditions (step 930). If a condition is satisfied, then the data transmission scheduling system starts data transmissions (step 940) to send the request including data locations to the wireless network 50. The schedule condition includes the task execution time, the next task execution time, the time interval of a repeated task, or the number of times for executing a task. After the server 200 receives the request, the server 200 prepares data (step 950) and establishes communications with the mobile communication device. Following a definite transmission protocol, the data are transmitted to the mobile communication device (step 960). The transmitted data locations include the server address, file addresses or commands to generate files on the server 200. After the data transmission is completed, record the executing results of the schedule task (step 970). The data transmission scheduling system continues detecting whether any schedule condition is satisfied and goes back to step 930 until confirm the completion of the task (step 980).

### EFFECTS OF THE INVENTION

The system automatically performs data transmissions according to the schedule tasks defined by the user in advance, so that repeated data transmission tasks can be defined to run several times. For transmissions of large volumes of data, the user can schedule them to be executed when the network is not busy. Thus, the invention can fully utilize the wireless network to increase the data transmission efficiency.

What is claimed is:

1. A data transmission scheduling system implemented on a mobile communication device for arranging a data update and download plan using the transmission character of a wireless network, which comprises:
a schedule defining module, which defines a schedule task for the data to be transmitted and sets a schedule condition for the schedule task;
a schedule adding module, which adds the schedule task defined in the schedule defining module to a schedule queue in the data transmission scheduling system;
a schedule removal module, which removes the executed and completed schedule task from the schedule queue constructed in the schedule adding module;
a schedule executing module, which executes the schedule task satisfied the schedule condition constructed in the schedule defining module;
a self-adjusting transmission module, which detects network communications conditions and automatically adjusts the execution time for the schedule executing module to execute the schedule task; and
a system starting module, which starts the data transmission scheduling system, monitors the running of the schedule defining module, the scheduling adding model, the schedule removal module, the schedule executing module, and the self-adjusting transmission module and becomes a routine.

2. The system of claim 1, wherein the data transmission scheduling system further comprises a schedule diary module to store the schedule task execution result.

3. The system of claim 1, wherein the schedule condition is selected from the group consisting of a transmitted data location, an execution time, and a number of execution times.

4. The system of claim 3, wherein the transmitted data location is selected from the group consisting of a server address, a file address, and a command for generating a file on a server.

5. The system of claim 3, wherein the execution time is selected from the group consisting of the current task execution time, the next task execution time, and the time interval of a repeated task.

6. The system of claim 1 further comprising a database forming a set of records.

7. The system of claim 6, wherein the record is selected from the group consisting of a schedule task record, a schedule queue record, and a schedule diary.

8. A data transmission scheduling method implemented in a mobile communication device for arranging a data update and download plan using the transmission character of a wireless network, which comprises the steps of:
defining a schedule task of data transmissions;
adding a defined schedule task to a schedule queue;
confirming a schedule condition of the schedule task; and
transmitting the schedule task corresponding to the satisfied schedule condition.

9. The method of claim 8 further comprising, after the step of transmitting the schedule task corresponding to the satisfied schedule condition, the steps of:
preparing the data through a server;
transmitting the data to the mobile communication device; and
recording the execution result of the schedule task.

10. The method of claim 8, wherein the step of defining a schedule task of data transmissions further comprises the steps of modifying and adding.

11. The method of claim 10, wherein the modifying step further comprises the steps of:
checking a schedule queue record;
displaying the schedule queue;
calling a schedule removal module to remove the already executed schedule tasks from the schedule queue; and
calling a schedule adding module to add the defined schedule task to the schedule queue in the data transmission scheduling system.

12. The method of claim 10, wherein the adding step further comprises the steps of:
editing the schedule queue; and
calling a schedule adding module.

13. The method of claim 8, wherein the step of adding the defined schedule task to the schedule queue further comprises the steps of:
adding the schedule task;
setting a string;
generating a data transmission; and
adding the data transmission to the schedule queue.

14. The method of claim 8, wherein the step of transmitting the schedule task corresponding to the satisfied schedule condition further comprises the steps of:
calling a self-adjusting transmission module to automatically adjust the execution time of the schedule task;
executing the data transmission;
calling a schedule diary module to record the execution result of the schedule task;
calling a schedule adding module; and
calling a schedule removal module.

15. The method of claim 14, wherein the step of calling the self-adjusting transmission module further comprises the steps of:
sending out a channel status detection command;
deleting the schedule task from the schedule queue;
generating a new schedule task; and
adding the new schedule task to the schedule queue.

16. The method of claim 14, wherein the step of calling the schedule removal module further comprises the steps of:
checking a record;
deleting the schedule task;
deleting a schedule diary; and
deleting the record.

17. The method of claim 16, wherein the record is selected from the group consisting of a schedule task record, a schedule queue record, and the schedule diary.

18. The method of claim 8, wherein the schedule task comprises a plurality of repeated transmissions.

19. The method of claim 8, wherein the data transmission scheduling system uses a self-adjusting transmission technology to detect the wireless network communication conditions before data transmissions in order to automatically adjust the execution time of the schedule task.

20. The method of claim 8, wherein the data are selected from the group consisting of static files and data dynamically generated by executing commands over the server.
